(19) United States
(12) Patent Application Publication
(10) Pub. No.: US 2005/0203243 A1
(43) Pub. Date: Sep. 15, 2005

(54) Composition and device for damping mechanical motion

(75) Inventor: Michael Polus, Nurnberg (DE)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Dow Corning GmbH

(21) Appl. No.: 11/058,768

(22) Filed: Feb. 15, 2005

Related U.S. Application Data
(63) Continuation of application No. PCT/EP03/08969, filed on Aug. 13, 2003.

(30) Foreign Application Priority Data
Aug. 15, 2002 (DE) 202 12 667.6
Mar. 7, 2003 (DE) 103 09 963.8

(51) Int. Cl. C08L 83/00

(52) U.S. Cl. 524/588

(57) ABSTRACT

A composition for damping mechanical motions, such as for damping of mechanical impacts or oscillations can include at least one collagen as well as at least one carrier matrix for the at least one collagen. The carrier matrix contains a formable material. The composition also can include at least one liquid having or containing polar molecules. The carrier matrix, the at least one collagen and the liquid form a mixture (or batch). A method for manufacturing a material for use in damping mechanism motions includes preparing an essentially non-cross-linked, liquid elastomer parent substance as well as providing a liquid collagen parent substance that contains at least one collagen and at least one liquid with polar molecules. The method also includes generating a mixture from the elastomer parent substance and the collagen parent substance as well as cross-linking molecules of the elastomer parent substance in the generated mixture.

### CROSS-REFERENCE TO RELATED APPLICATIONS

The present application is a continuation of International PCT Application No. PCT/EP2003/008969, filed on Aug. 13, 2003, entitled “Zusammensetzung und Vorrichtung zum Dämpfen Mechanischer Bewegung” (“Composition and Device for Dampening Mechanical Action”), which claims priority to German Application No. 103 09 963.8, filed on Mar. 7, 2003, and to German Application No. 202 12 667.6, filed on Aug. 15, 2002. The entire contents of the aforementioned references are incorporated herein by reference.

### BACKGROUND OF THE INVENTION

1. The Field of the Invention

The invention relates to a composition and a device for damping mechanical motion, in particular impacts and oscillations.

2. Background and Relevant Art

Damping elements consisting of damping materials are known for damping mechanical motions. Such damping materials internally convert the momentum or kinetic energy into heat energy or thermal energy. This irreversible loss of kinetic energy through conversion into thermal energy is also referred to as dissipation. Damping or dissipation diminishes or absorbs the momentum of the mechanical motion, and dampens the motion, in particular the force on impact or the amplitude of an oscillation in the damping element. In order to return the damping element to its original shape after exposure to a mechanical load, the damping elements generally consist of materials that are simultaneously resilient, and thus exert a restoring force opposing their deformation to reestablish the original shape.

Damping elements for the damping of impacts are known in particular in the soles of orthopedic shoes or sports shoes, while damping devices are known for damping or absorbing oscillations, in particular to protect vibration-sensitive devices or decouple strongly vibrating devices.

Latex (rubber emulsions) and foam rubber, polyurethane flexible foams and EVA foams are known as damping materials especially for shoes in the area of orthopedics.

Collagens are long-chained albumens or proteins in the human or animal body, which have low expandability and stiffness, and impart high tensile strength to fibers. Collagens are the building material for tendons, bones and connective tissue in the body. Based on what we know today, the collagen molecular structure is generally composed of three chains spirally twisted in a narrow triple helix. Many different types of collagens have been discovered to date. Collagens normally contain the amino acids glycine, proline, hydroxyproline, lysine and hydroxylysine. Some types of collagen are glycosylated. Most collagen types form fibers or fibrils, but can be additionally connected or cross linked, as a rule using lysine side chains. The side bonds or cross linkages enable the formation of membranes or flat tissue structures, e.g., in the skin and many organs.

Collagens themselves are water insoluble, but denature when heated just like all proteins, and gradually change into gelatins in water when heated, which are known to be soluble in hot water, and already form solid gel types when cooled in a 1% solution. Gelatins are used in foodstuffs, e.g., gummy bears and jellied meats. Collagens are also called “glue makers”, because they adhesively form highly swelling proteins in water; and water-soluble glue forms as the formed gelatin solution is further heated. The totality of water-soluble protein products obtained from collagen, including gelatins and glue, is referred to as glutin. In light of their importance for the human body, collagens are used in medical and cosmetic applications, e.g., in plastic surgery, as a nutritional supplement or in skin cosmetics. The glues obtained from the collagens are used as natural glues in building instruments.

A rubber compound known from EP 0 481 430 A2 contains pulverized leather with a small grain size of less than 250 μm in addition to rubber castings. This compound is proposed for vibration dampers, sound dampers, shoes like rubber shoes and shoe soles, among other things. EP 0 481 430 A2 states that using gelatins in place of pulverized leather is disadvantageous, because the surface becomes undesirably sticky (page 3, line 16).

U.S. Pat. No. 4,957,509 A discloses a ceramic implant with a matrix comprising zirconium or silicon nitride ceramics, wherein the matrix is porous and contains a substance adapted to living tissue, wherein this substance can also be or contain collagen. The ceramic matrix makes the ceramic implant a rigid body having no resilient or damping properties.

U.S. Pat. No. 4,711,670 A discloses a moistening substance for offset printing, which does not encompass cross-linked collagen.

EP 0 360 180 A2 relates to a method for manufacturing collagen foams in the form of continuous loops and their use in medicine, cosmetics and hygiene.

U.S. Pat. No. 5,624,463 A discloses an artificial cartilage for implantation in a human body, in which collagen can be present in a matrix.

Patent Abstracts of Japan, Vol. 018, No. 491 (M-1672) and accompanying JP 06 15908 A discloses an insulating support element for buildings in which steel or copper metal plates and rubber disks or rubber layers are alternately laminated with each other, yielding a foundation insulating support element. This support element is used to enhance the earthquake safety of a building. In order to improve adhesion of the rubber material to the metal plates along with the creep properties, it is proposed that the rubber material be provided with pulverized, natural collagen fibers. The collagen fibers also serve to increase creep resistance, meaning in the excessive tensioning area in which purely elastic deformation no longer arises.

DATABASE WPI Week 198912 Derwent Publications Ltd., London, kGB; AN 1989-088950 and JP 01 038795 A disclose a sound wave absorber with an oxidized polymer based on quinone, which is combined with a water-soluble, high-molecular additive, e.g., methylcellulose or gelatin.

GB 1 361 540 discloses a method for manufacturing powdered mixtures of elastomer and collagen proteins, in which the powdery mixture is used as a binder in a cast or injection-molded product, e.g., a shoe sole or flat material. The collagen is here used to reinforce the natural or synthetic elastomers.

EP 0 568 334 A1 discloses a collagen-containing sponge for administering medication to improve wound healing.

EP 0 801 105 A1 discloses a resin composition with a thermoplastic elastomer, in particular an olefin elastomer, a natural collagen and silicone. According to the description, this mixture can be used to cast a product with a sufficient hardness. The collagen is added in powder form.

### BRIEF SUMMARY OF THE INVENTION

One object of the invention is now to provide a composition having good mechanical damping properties, along with a mechanical device for damping mechanical motion, in particular due to an impact or oscillation, which exhibits good damping properties.

This object is achieved according to the invention by a composition with the features in claim 1 and a device with the features in claim 27. Advantageous embodiments, further developments and applications of the composition and the device according to the invention may be gleaned from the respective dependent claims of claim 1 and claim 27. Claims 21 to 26 describe advantageous manufacturing method for manufacturing a composition according to the invention.

The invention is based on the new knowledge that the collagens previously known only relative to the human or animal body can dissipate or absorb a high level of mechanical energy in technical applications due to their special molecular structures, allowing them to dampen motion or deformation. Based on what we know today, this can likely be explained by the fact that the collagen molecules react to a motion or deformation to be dampened via stretching, torsion and/or yielding, or by another change in the intramolecular spatial structure, thereby absorbing the mechanical energy that is subsequently practically irreversibly dissipated again in the composition. The observed damping properties exhibited by the first compositions and damping devices manufactured with collagen were so outstanding as to yield very interesting areas of application for the invention in light of the easy and cost-effective availability of collagens.

The composition (or “the substance”, “the material”) according to claim 1 is mechanically damping, and is suitable, preferably also intended, in particular for damping mechanical motions, especially of mechanical impacts or oscillations, and includes at least the following constituents:
at least one collagen;
at least one carrier matrix (or a carrier material), a surrounding material structure, an embedding material) for the collagen(s), wherein the carrier matrix contains at least one reversible, in particular resilient, formable (or deformable) material; and
at least one liquid with polar molecules.

The material(s) in the carrier matrix, the liquid(s) and the collagen(s) are mixed together, blended thoroughly or intersperse each other in a mixture (or batch), and can in particular also exhibit chemical or physical bonds with each other, although these must not significantly alter the chemical nature of the individual constituents in the composition. Therefore, the collagen or collagens is/are contained or embedded in the carrier matrix.

The polar liquid molecules, in particular water molecules, accumulate on the collagen molecular structures. An outward deformation or motion now displaces or shifts the accumulated molecules, thereby additionally dissipating the deformational or kinetic energy. As a result, the damping effect can be further improved via the accumulation and displacement of liquid molecules, in particular water molecules, in the area of the collagen molecules.

The mixture (or batch) comprised of the carrier matrix and the collagen(s) can now form a damping element to dampen a mechanical motion. In addition to incorporating the collagen molecules, the carrier matrix also acts to support the re-formation or reshaping of the composition or a damping element based on this composition after a deformation.

According to claim 27, a device for damping mechanical motions, in particular mechanical impacts or oscillations, is provided with a composition according to the invention (or with a liquid-containing batch interspersed with collagen).

The collagen(s) is/are preferably at least partially swelled or swelled, in particular with the supply of liquid and, if needed, heat.

The liquid is or contains preferably water or one or more alcohols or glycerin.

The gravimetric percentage of liquid or polar molecules preferably ranges between about 0.5% w/w (percent by weight) and about 90% w/w relative to the overall weight of the composition.

In particular in the case of swelled collagen, the collagen molecules can be partial molecules or partial strands with a collagen molecular structure that are shortened relative to collagen molecules arising in the human or animal body, since even such shortened molecular strands induce the desired dissipation.

The percent by weight of the collagen/collagens generally ranges between 0.01% w/w and about 95% w/w relative to the overall weight of the composition, in particular between 1% w/w and about 40% w/w, and preferably between about 2% w/w and about 10% w/w. Therefore, comparatively small quantities of collagen are already sufficient to achieve a damping effect.

The collagen(s) is/are preferably present at least primarily in the form of fibers or fibrous molecular structures, and consist(s) especially of albumen (protein)-based molecular chains comprised essentially of three helically intertwined molecular chains.

The arrangement and/or alignment of collagen fibers or fibrous collagen molecular structures can now be at least largely uniform in one embodiment, in particular along at least one preferred direction. This impressed alignment of the collagen molecules, which can be referred to as having an anisotropic structure, can be used to realize a direction-dependent damping, i.e., a motion can be dampened most strongly in one direction than in another.

In an alternative embodiment, the fibers or fibrous molecular structures formed by the collagen(s) are at least primarily non-uniformly or randomly or statistically distributed and/or aligned. Directionally independent damping arrangements can be achieved with such an isotropic structure.

The collagen(s) can also have at least a partially cross linked structure, realized in particular via cross links, e.g., lysine connections, between the collagen fibers or fibrous collagen molecular structures. Depending on the level of cross linking, in particular a merely two-dimensional or three-dimensional cross linking, collagen structures are produced with a flat or spatial structure, and potentially anisotropic or isotropic damping properties.

In a special embodiment, at least a part of the collagen is tempered, i.e., subjected to heat treatment.

The percent by weight of the reversibly deformable material, in particular of the elastomer, preferably measures between 5% w/w and 99.9% w/w relative to the overall weight of the composition.

The reversible, in particular essentially resilient, deformable material(s) of the carrier matrix is/are preferably comprised of one or more elastomers, in particular based on preferably cross-linked, natural rubber(s) and/or synthetic rubber(s). Synthetic rubbers are generally linear polymers or chain polymers cross-linked via vulcanization or loose cross-linking, thereby receiving flexible properties. Saturated (in particular so-called M elastomers) or unsaturated (so-called R elastomers) synthetic rubbers and elastomers can be used.

One especially preferred resilient material for the carrier matrix is a siloxane elastomer (SI), which generally consists of cross-linked polysiloxanes or polysiloxane compounds, in particular a siloxane rubber (SIR, siloxane rubber), earlier also referred to as silicone rubber. Silicone rubber is generally formed out of cross-linked high-molecular polydimethyl siloxanes (Q), wherein a part of the methyl groups can be replaced by phenyl groups (PMQ) or vinyl groups (VMQ). Vulcanization or cross linking can involve in particular hot cross linking, in particular with peroxides, or cold cross linking, in particular with platinum compounds, organic tin compounds or amines, or also be present directly in a one-component siloxane rubber.

Siloxane elastomers are heatproof, and pose practically no hazard to the health and environment.

However, other synthetic rubbers can also be used. The following is an incomplete list of possible elastomers and elastomer compounds.
Butadiene elastomers (BR);
Styrene/butadiene elastomers (SBR);
Acrylnitrile/butadiene elastomers (NBR);
Isoprene elastomers (IR, NR)
Isoprene/isobutylene copolymers (butyl rubber)
Vinyl elastomers, in particular ethylene propylene copolymers (EPDM, EPM), ethylene vinyl acetate copolymers (EVAC), acryl rubber (ACM), polyisobutylene (PIB);
Urethane rubber (PUR)

It is also possible to use:
Thermoplastic elastomers (TPE) in particular, which are formable, and hence especially easy to recycle.

The elastomer(s) or reversibly formable material(s) of the carrier matrix can also be present in a foamed state or as foam in an advantageous embodiment, and/or the carrier matrix can exhibit gas pockets.

The impact resilience (rebound resilience) of an elastomer decreases as its damping increases. The impact resilience of the elastomer in the composition according to the invention can now be set distinctly higher than in known damping materials that consist only of elastomers, since the collagen significantly improves the damping properties of the composition.

To protect the composition against freezing or frost, a special further development provides for antifreeze, e.g., glycol, for reducing the freezing point.

One advantageous method for manufacturing a composition according to the invention encompasses the following procedural steps:
a) An essentially still non-cross-linked, liquid, generally viscous or thick elastomer parent substance (or elastomer source) is prepared;
b) A liquid collagen parent substance (or collagen source) with at least one collagen and at least one liquid is also provided;
c) The elastomer parent substance and the collagen parent substance are blended or thoroughly mixed;
d) The molecules of the elastomer parent substance are cross-linked in the generated mixture, in generally a three-dimensional manner.

The elastomer is therefore cross linked or hardened in the mixture, so that cross-linking of the elastomer molecules causes the collagen molecules to become embedded or included in the mixture even more.

The collagen parent substance contains in particular at least one liquid for swelling the collagen(s), in particular water, alcohol(s) and/or glycerin. Gelatin having a defined collagen content and usually obtained from animal skin, cartilage and joints is preferably used or generated as the collagen parent substance. The gelatin is preferably reacted with water, during which the collagen is swelled, and liquefies while heated, typically at temperatures of around 80° C.

The mixture is usually hardened during cross-linking with the formation of a deformable, but no longer free-flowing or liquid body.

The body is preferably molded into a desired shape by introducing the liquid mixture of elastomer parent substance and collagen parent substance into a mold (a thermoforming mold), and having the cross-linking process take place at least primarily in the mold initially, and then taking the body hardened by the mixture out of the mold.

As an alternative, however, the elastomer parent substance and collagen parent substance can be sprayed onto a film or other flexible carrier, and the film can then be wound into a hose or roll.

In a preferred embodiment, the damping device encompasses one or more damping elements, which contain(s) the collagen(s). The damping elements generally deform when exposed to a kinetic force, and dampen the motion via intense dissipation with the help of the collagen molecules. Given several damping elements, they can be arranged in a grid relative to each other, in particular to reflect a spatial distribution of the load.

In a further development according to the invention, the damping device encompasses at least one sheath (or “sleeve”, “jacket”), which incorporates at least one damping element. The sheath is used to protect the collagen-containing damping material, and in an especially advantageous embodiment, supports the reformation of the deformed damping element via the selection of a suitable, reversible, in particular resilient, deformable material for the sheath. The damping element and sheath are preferably connected to better couple the deformation of the damping element and sheath.

In an advantageous further development, the sheath interior can be provided with at least one escape area, into which the damping element can escape during deformation. As an alternative or in addition, the damping element or carrier matrix or the mixture can incorporate gas pockets in which the adjacent damping material with the collagen can escape during deformation.

The composition and damping device according to the invention can be used for many different applications to dampen impact or oscillation.

A first advantageous application of the composition or device involves protecting the human body against mechanical impacts and/or in a shoe, in particular in a shoe sole or shoe insert, and/or in a helmet.

A second advantageous application of the device involves use for damping oscillations or vibrations between two mechanical elements.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings. Corresponding parts are labeled with the same reference numbers. In particular, the drawings show diagrammatic views where:

FIG. 1 illustrates a device for damping mechanical motion in an unloaded state;

FIG. 2 illustrates the device according to FIG. 1 exposed to impact, where “S” denotes the direction of impact; and

FIG. 3 illustrates the device according to FIG. 1 and 2 after the load has been removed.

### DETAILED DESCRIPTION OF THE PREFERRED EMBODIMENTS

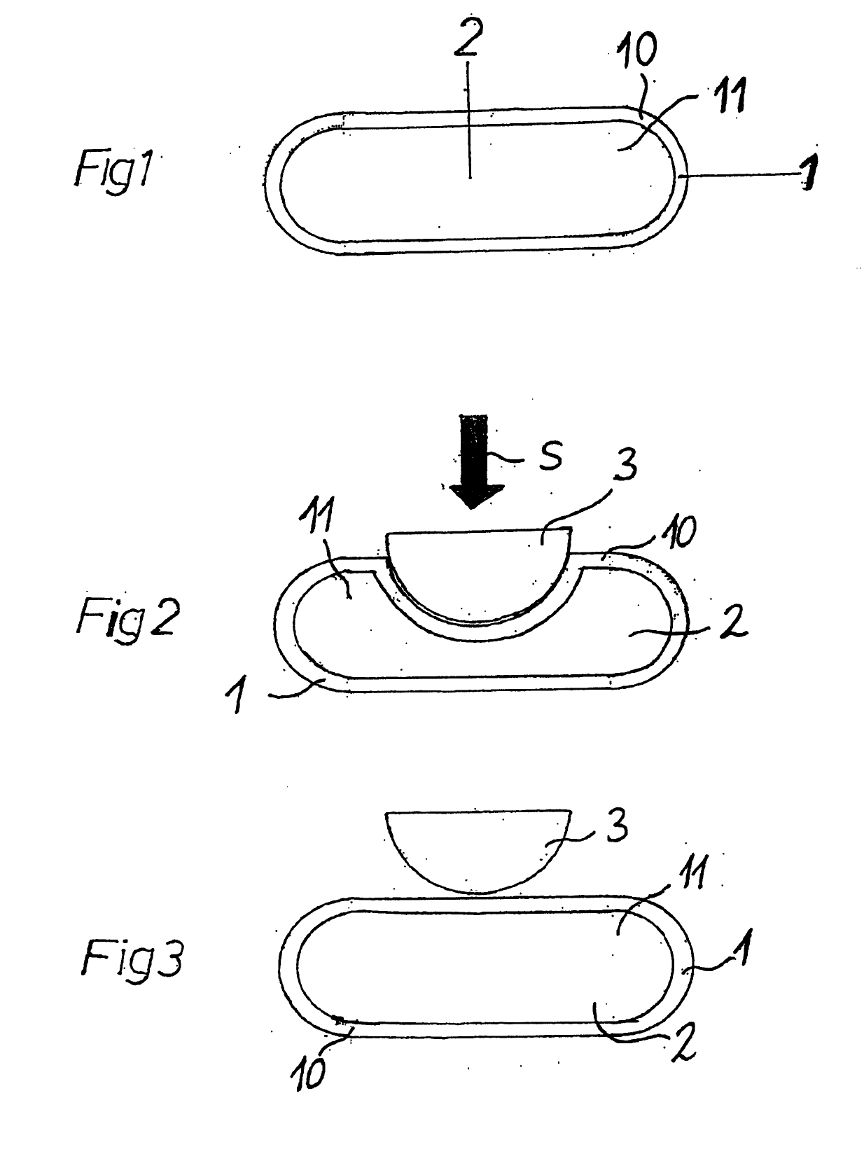

The device according to FIG. 1 to 3 encompasses a deformable basic element 1, which has a sleeve or sheath 10 and an interior area or space 11 enveloped by the sheath 10. A damping material or damping element 2 is arranged inside the interior space 11. The damping material or damping element 2 is designed as a liquid-containing batch, and along with liquid, preferably water, contains at least a collagen and other carrier materials of a carrier matrix for the collagen, in particular an elastomer like siloxane rubber (silicone rubber).

As shown on FIG. 2, a moving element 3 exerting an impact in the direction of impact S denoted by the arrow forms or deforms the basic element 1. The deformation of the damping material or damping element 2 yields hydrodynamic effects that induce a high-level hydraulic damping owing to the presence of the collagens.

After the impact and upsetting deformation, the original defined shape is again restored via the resilient sheath 10 and a shape memory or a reversible formability of the batch, as shown on FIG. 3.

This process of forming and demolding is reversible, and can be cyclically repeated as desired.

In order to achieve a permanent hydraulic impact damping, the liquid, in particular, is also accelerated in the cyclic operation according to the invention, thereby generating a cyclic hydrodynamic damping effect.

The damping capacity of the device is controlled and determined by its shape on the one hand, and also by the suitable mixture and composition of the liquid-collagen-carrier matrix mixture.

One preferred mold of the basic element 1 is a flat basic mold with two opposing flat sides, as shown on FIG. 1 to 3. In addition, the basic element 1 can be provided with several individually separated chambers, in which respective damping material is provided. In addition, the interior space 11 of the sheath 10 can also incorporate empty chambers or areas into which the damping material 2 can move during upsetting deformation, in order to escape deformation.

In addition to collagen, liquid and the resilient material, the damping material 2 preferably also encompasses a material that facilitates removal from a mold, such as cornstarch.

The carrier matrix for the collagen, which consists of a resilient material, e.g., latex or silicone rubber, exerts a resilient action and makes forming reversible. The collagen takes up or absorbs the mechanical energy during impact or upsetting deformation, thereby generating a very soft impact characteristic. The carrier matrix and/or the mixture can additionally comprise other substances, e.g., antifreeze, in particular glycol or glycerin.

Table 1 shows a generally preferred composition for the damping material of the damping element 2.

TABLE 1

| | | |
|---|---|---|
| 0.01-95% | w/w | Collagen |
| 0-99.9% | w/w | Elastomer, in paritcular silicone rubber |
| 0-50% | w/w | Starch, in particular cornstarch |
| 0-15% | w/w | Other ingredients, e.g., antifreeze |

Table 2 shows an advantageous composition of the damping material.

TABLE 2

| | |
|---|---|
| 2-10% w/w | Collagen |
| 0-98% w/w | Elastomer, in paritcular silicone rubber |
| 0-50% w/w | Starch, in particular cornstarch |
| 0-15% w/w | Other ingredients, e.g., antifreeze |

Table 3 shows the percentages by weight of the components in Tables 1 to 3 that always yield 100% w/w.

TABLE 3

| | |
|---|---|
| 3-4 % w/w | Collagen |
| 0-97 % w/w | Elastomer, in paritcular silicone rubber |
| 0-50 % w/w | Starch, in particular cornstarch |
| 0-15 % w/w | Other ingredients, e.g., antifreeze |

Even when exposed to a load of 5,000 tons per square meter, such a mixture or composition always exhibits a reversible formability or shape memory.

The device according to the invention can be used for any technical application as a hydraulic or hydrodynamic impact damper. Possible applications include in particular protecting the human body against impact and shock loads, in particular as relates to shoes, orthopedics and safety. Shoes, shoe inserts or shoe soles in orthopedics or sports shoes, other orthopedic articles, helmets, gloves or the like can all be fitted with the impact damping device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A composition, preferably for damping mechanical motions, in particular of mechanical impacts or oscillations, comprising:
a) at least one collagen;
b) at least one carrier matrix for the at least one collagen, wherein the carrier matrix contains at least one reversibly, in particular resiliently, formable material; and
c) at least one liquid having or containing polar molecules;
d) wherein the carrier matrix, the at least one collagen and the liquid form a mixture.

2. A composition according to claim 1, in which the at least one collagen is embedded in the carrier matrix, or is interspersed throughout the carrier matrix.

3. A composition according to claim 1, in which the at least one collagen is present primarily in the form of fibrous or longitudinally stretched molecular structures.

4. A composition according to claim 3, in which the fibrous or longitudinally stretched molecular structures formed by the at least one collagen are at least primarily uniformly arranged or aligned along at least one preferred direction.

5. A composition according to claim 3, in which the fibrous or longitudinally stretched molecular structures formed by the at least one collagen are at least primarily non-uniformly or randomly arranged or aligned.

6. A composition according to claim 3, in which the fibrous or longitudinally stretched molecular structures of the at least one collagen comprise essentially three helically intertwined, protein based molecular chains.

7. A composition according to claim 3, in which the at least one collagen has at least a partially cross-linked structure, realized in part via lysine cross links between the fibrous or longitudinally stretched molecular structures.

8. A composition according to claim 1, further comprising at least partially conditioned collagen.

9. A composition according to claim 1, further comprising at least partially swelled collagen.

10. A composition according to claim 1, further comprising partial molecules or strands with a collagen molecular structure, wherein the partial molecules or strands are shortened relative to collagen molecules arising in the human or animal body.

11. A composition according to claim 1, wherein the at least one collagen reacts to a motion or deformation to be dampened via at least one of stretching, torsion or yielding, or by another change in its intramolecular spatial structure, and thereby absorbs mechanical energy of the motion or deformation that is subsequently irreversibly dissipated in the composition.

12. A composition according to claim 3, in which the polar molecules of the liquid accumulate on the at least one collagen or collagen molecular structures, and are displaced or shifted by an external deformation or motion, thereby dissipating the deformation or kinetic energy.

13. A composition according to claim 1, wherein the at least one liquid comprises at least one of water, one or more alcohols, or glycerin.

14. A composition according to claim 1, wherein the liquid or polar molecules are contained in a percentage by weight of between about 0.5% w/w and about 90% w/w relative to the overall weight of the composition.

15. A composition according to claim 1, wherein the carrier matrix contains at least one elastomer or a compound of elastomers as the resiliently deformable material.

16. A composition according to claim 15, wherein the carrier matrix contains at least one of, preferably cross-linked or vulcanized, natural rubber, synthetic rubber, and at least one siloxane elastomer such as a siloxane rubber as the elastomer(s) or for the composite of elastomers.

17. A composition according to claim 15, wherein the carrier matrix or at least one elastomer comprises a foam in which the carrier matrix incorporates gas pockets.

18. A composition according to claim 1, wherein the at least one reversibly, in particular resiliently, formable material in the carrier matrix is present in a percentage by weight of between 5% w/w and 99.9% w/w relative to the overall weight of the composition.

19. A composition according to claim 1, wherein the at least one collagen is present in a percentage by weight of between about 0.01% w/w and about 95% w/w, in particular between 1% w/w and about 40% w/w, and preferably between about 2% w/w and about 10% w/w, relative to the overall weight of the composition.

20. A composition according to claim 1, further comprising at least one antifreeze component.

21. A method for manufacturing a composition, preferably for damping mechanical motions, in particular mechanical impacts or oscillations, comprising:
a) preparing an essentially non-cross-linked, liquid elastomer parent substance;
b) providing a liquid collagen parent substance, which contains at least one collagen and at least one liquid with polar molecules;
c) generating a mixture from the elastomer parent substance and the collagen parent substance; and
d) cross-linking molecules of the elastomer parent substance in the generated mixture.

22. A method according to claim 21, wherein liquid gelatins are used as the collagen parent substance, the method further comprising reacting the gelatins with water such that the at least one collagen is swelled, and liquefying the at least one collagen at a temperature of about 80° C.

23. A method according to claim 21, further comprising hardening the mixture during cross-linking, such that the mixture is no longer in a liquid state.

24. A method according to one of claim 21, further comprising introducing the liquid mixture of the elastomer parent substance and the collagen parent substance into a mold, such that cross-linking initially takes place at least primarily in the mold; and removing the body hardened by the mixture out of the mold.

25. A method according to one of claim 21, further comprising spraying the elastomer parent substance and the collagen parent substance onto a film, and winding the film into a hose or roll.

26. A method according to one of claim 21, wherein the liquid in the collagen parent substance is used to swell the at least one collagen with at least one of water, alcohol, or glycerin.

27. A device for damping mechanical motion, in particular of an impact or oscillation, the device including at least one element made at least in part from a composition comprising:
a) at least one collagen;
b) at least one carrier matrix for the at least one collagen, wherein the carrier matrix contains at least one reversibly, in particular resiliently, formable material; and
c) at least one liquid having or containing polar molecules;
d) wherein the carrier matrix, at least one collagen and the liquid form a mixture.

28. A device according to claim 27, wherein the at least one element is a resiliently deformable damping element that contains the composition.

29. A device according to claim 28, further comprising at least a sheath, which incorporates the at least one resiliently deformable damping element in its interior space.

30. A device according to claim 29, wherein the resiliently deformable damping element is connected with the sheath.

31. A device according to claim 29, wherein the sheath interior comprises at least one escape area into which the resiliently deformable damping element can at least partially escape during deformation.

32. A device according to claim 27, further comprising a plurality of resiliently deformable damping elements arranged in a grid.

33. A device according to claim 27, wherein the device is configured to be placed in a shoe, in particular in a shoe sole, or to be placed in a foot bed, in a shoe insert, or in a helmet.

34. A device according to claim 27, wherein the device is configured for damping oscillations between two mechanical elements
